(19) United States
(12) Patent Application Publication
(10) Pub. No.: US 2024/0422220 A1
(43) Pub. Date: Dec. 19, 2024

(54) Power Tools, Wireless Communication Devices, and Methods for Jobsite Inventory Checks of Power Tools in a Mesh Network

(71) Applicant: Milwaukee Electric Tool Corporation, Brookfield, WI (US)

(72) Inventors: Anthony M. Davis, Brookfield, WI (US); Chris J. Burkhardt, Brookfield, WI (US); Steven M. Stefanik, Brookfield, WI (US)

(21) Appl. No.: 18/689,389

(22) PCT Filed: Sep. 9, 2022
(86) PCT No.: PCT/US2022/043022

§ 371 Date: Mar. 5, 2024

Related U.S. Application Data
(60) Provisional application No. 63/242,717, filed on Sep. 10, 2021.

(51) Int. Cl. H04L 67/12; B25F 5/00

(52) U.S. Cl. CPC H04L 67/12; B25F 5/00

(57) ABSTRACT

A power tool, a wireless communication device, and method for jobsite inventory checks are provided. The power tool (104) include a body, an actuator, an antenna (240), and an electronic controller (210) in communication with the antenna (240). The electronic controller (210) includes a processor (220) configured to receive a mesh mode message requesting that the power tool (104) enable a mesh communication mode, receive an inventory check message originating from a wireless communication device, retransmit the inventory check message to at least one additional power tool in a mesh network with the power tool (104), receive an additional tool identifier from each of the at least one additional power tools in the mesh network, and transmit, in response to the inventory check message, a tool identifier for the power tool (104) and each of the additional tool identifiers.

### RELATED APPLICATIONS

The present application is based on and claims priority from U.S. Patent Application No. 63/242,717, filed on Sep. 10, 2021, the entire disclosure of which is incorporated herein by reference.

### BACKGROUND

Work tools (e.g., power tools) allow operators to implement various functionalities on many different components (e.g., electrical wires, power cables, sheet metal, etc.). For example, some power tools can include a cutting head that is driven (e.g., hydraulically, or electrically) into a component, such as a power wire, to cut through the component.

### SUMMARY

Some embodiments of the disclosure provide a power tool. The power tool can include a body, an actuator coupled to the body, an antenna coupled to the body, and an electronic controller coupled to the body and in communication with the antenna. The electronic controller can include a processor that can be configured to receive a mesh mode message requesting that the power tool enable a mesh communication mode, receive an inventory check message originating from a wireless communication device, retransmit the inventory check message to at least one additional power tool in a mesh network with the power tool, receive an additional tool identifier from each of the at least one additional power tools in the mesh network, and transmit, in response to the inventory check message, a tool identifier for the power tool and each of the additional tool identifiers.

Some embodiments of the disclosure provide a method for determining an inventory for a location. The method can include receiving, using a power tool, a mesh mode message requesting that the power tool enable a mesh communication mode, receiving, using the power tool, an inventory check message originating from a wireless communication device, retransmitting, using the power tool, the inventory check message to at least one additional power tool in a mesh network with the power tool, receiving, using the power tool, an additional tool identifier from each of the at least one additional power tools in the mesh network, and transmitting, using the power tool and in response to the inventory check message, a tool identifier for the power tool and each of the additional tool identifiers.

Some embodiments of the disclosure provide a wireless communication device. The wireless communication device can include a body, an antenna coupled to the body, and an electronic controller coupled to the body and in communication with the antenna. The electronic controller can include a processor that can be configured to transmit a mesh mode message to a power tool. The mesh mode message can request that the power tool enable a mesh communication mode. The processor can be configured to transmit an inventory check message to the power tool, and in response to the inventory check message can receive a tool identifier from the power tool. The tool identifier can identify the power tool. In response to the inventory check message the processor can be configured to receive at least one additional tool identifier from the power tool. Each of the at least one additional tool identifiers can identify a respective additional power tool that is in a mesh network with the power tool. The processor can be configured to indicate an inventory of power tools in the mesh network. The inventory of power tools can indicate a presence of the power tool and each additional power tool based on receipt of the tool identifier and the at least one additional tool identifier.

### BRIEF DESCRIPTION OF THE DRAWINGS

The accompanying drawings, which are incorporated in and form a part of this specification, illustrate embodiments of the disclosure and, together with the description, serve to explain principles of the embodiments:

FIG. 1 is a schematic illustration of a power tool system.

FIG. 2 shows a block diagram an example of a power tool.

FIG. 3 shows a block diagram of a wireless communication device.

FIG. 4 shows a flowchart of a process for implementing an inventory check in a mesh network.

FIG. 5 shows a schematic illustration of a power tool system with a mesh network having been established.

FIG. 6 shows a flowchart of a process for determining an inventory (e.g., of power tools) in a mesh network.

### DETAILED DESCRIPTION

As described above, power tools generally can implement various functionalities on different components. For example, power tools generally can include an actuator including a moveable component that when moved into contact with the component, implements some kind of functionality on the component. For example, when the power tool is implemented as a cutting tool, the actuator of the cutting tool can include a cutting head that can, when moved into contact with a work piece (e.g., a wire to be cut) sever the work piece in two. As another example, when the power tool is implemented as a crimping tool, the actuator of the crimping tool can include a crimping head that can, when moved into contact with a work piece (e.g., a wire to be crimped), crimp the work piece (e.g., to create an electrical connection to the wire). As another example, when the power tool is a drill-driver, the actuator of the power tool may be a drill chuck configured to accept and retain a drill or driver bit and that is driven by the power tool to rotate the retained bit to, for example, drill a hole in a workpiece (in the case of a drill bit) or drive a fastener into a workpiece (in the case of a drive bit).

Some power tools can include an electronic controller that can control various features of the tool. For example, the electronic controller can drive extension (or rotation or oscillation) of the actuator to implement a functionality on a work piece, or can drive retraction (or rotation in the opposing direction) of the actuator (e.g., after the functionality has been completed or to remove a fastener). In some embodiments, the electronic controller of the power tool can receive data from sensors of the power tool, which can augment the control of the actuator. For example, one sensor can be a trigger sensor that is coupled to the power tool. When a trigger of the power tool is actuated (e.g., depressed by an operator), the trigger sensor may sense and indicate the trigger depression to the electronic controller, which controls the actuator (e.g., to extend, rotate, or oscillate) to implement the functionality of the power tool.

In some cases, multiple different power tools can be located at different positions within a location (e.g., a bounded geographic location, a jobsite, etc.), and it can be desirable to have an inventory of all the power tools at the location. In this way, an operator can review the inventory (e.g., search the inventory) to determine if the location has a power tool needed for a particular task (e.g., a power drill-driver for installing drywall within a building). Then, if the type of power tool is within the inventory, the operator knows that the type of power tool is somewhere at or within the location. Alternatively, if the type of power tool is not within the inventory, then the operator knows that the type of power tool is not at or within the location, and thus should act accordingly (e.g., retrace steps including checking other locations including a workshop, purchase the type of tool, rent the type of tool, etc.). In some cases, having a current inventory can be advantageous for determining discrepancies when compared to a predetermined inventory. For example, a company (e.g., a construction company) can create a predetermined inventory that lists each power tool (and the corresponding type thereof) owned by the company. Then, periodically, the current inventory can be determined, and compared to the predetermined inventory to determine discrepancies between them. In this way, the company can ensure that all the desired power tools are within one or more work vehicles before traveling to or departing from the location. This process can be determined periodically (e.g., each time the one or more vehicles arrive at or depart from the location), and if a discrepancy has been determined, an operator can be notified accordingly (e.g., the operator can receive information detailing which of the power tools from the predetermined inventory is not within the current inventory), can receive an alert, etc.

In some cases, a wireless communication device can be in direct communication (e.g., wirelessly) with each power tool, and thus the wireless communication device can determine the inventory, based on each power tool directly communicating with the wireless communication device (e.g., the wireless communication device receiving an identification for each power tool). However, the maximum direct communication range between the wireless communication device and each power tool can place restrictions on the accurate determination (and thus listing) of all the power tools in the inventory. In other words, the maximum direct communication range can lead to some of the power tools being unable to communicate with the wireless communication device, and thus not being properly listed in the inventory. For example, some power tools can be placed at positions in which the distance between each of these power tools and the wireless communication device is too great for direct communication between them. Thus, even though these power tools are positioned at the jobsite, the identification for each of these power tools is not received by the wireless communication device, and as such, these power tools are not listed in the inventory thereby resulting in an inaccurate inventory. Accordingly, the inability of power tools to communicate with a wireless communication device (e.g., from the power tool being placed too far away from the wireless communication device) can result in inaccurate inventory determinations.

Some embodiments described herein provide solutions to these problems (and others) by providing improved systems and methods for jobsite inventory checks. For example, some embodiments of the disclosure provide a power tool system that can include a plurality of power tools, each with a tool identification associated therewith, and a wireless communication device. The wireless communication device can communicate with one of the power tools (or a different node) to prompt the power tool (or node) to establish a mesh network with the wireless communication device, each of the power tools, and each node (if applicable). In this way, each power tool identification can be disseminated through the mesh network to the wireless communication device. Thus, power tools that exceed the direct communication range between them and the wireless communication device can still be in indirect communication with the wireless communication device, via the mesh network, to transmit their identification to the wireless communication device. As such, establishing the mesh network can considerably increase the commination range between each power tool and the wireless communication device (e.g., via intermediary power tools, or nodes, of the mesh network).

In some embodiments, each power tool of the power tool system can include one or more antennas (e.g., as part of one or more Bluetooth® wireless modules) that are capable of communicating with other devices (e.g., other power tools) according to a Bluetooth® wireless protocol, which can have advantages as compared to other wireless protocols (e.g., using less power to communicate, providing fast communication speeds, ensuring one-to-one pairing between devices at some times, etc.). Thus, in some cases, the mesh network can be a Bluetooth mesh network. In this case, for example, the direct communication range between the wireless communication device and a respective power tool can be fairly short (e.g., 25 or 30 feet), but by using the Bluetooth mesh network, the indirect communication range can be increased considerably as compared to the direct communication range.

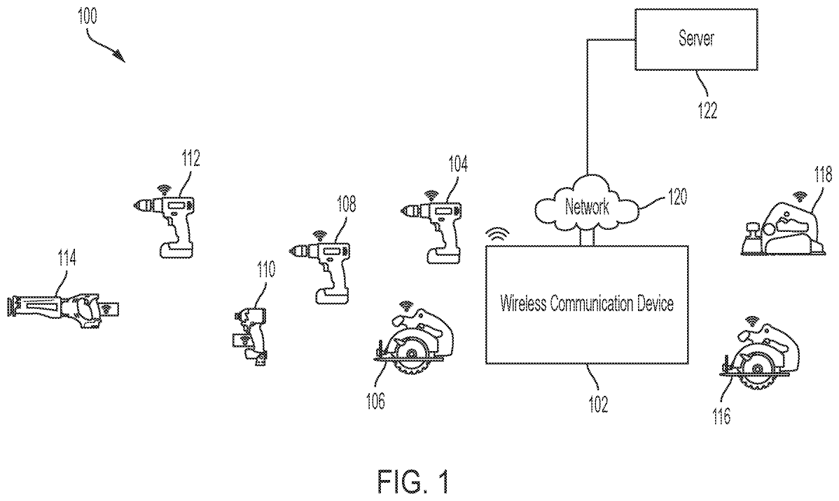

FIG. 1 shows a schematic illustration of a power tool system 100. The power tool system 100 can include a wireless communication device 102, and power tools 104, 106, 108, 110, 112, 114, 116, 118. The wireless communication device 102 can be configured to directly (and indirectly) communicate with each power tool 104, 106, 108, 110, 112, 114, 116, 118. For example, the wireless communication device 102 can define a direct communication range in which tools (or devices) positioned within the direct communication range can directly communicate with the wireless communication device 102 (e.g., the wireless communication device 102 and a corresponding device can directly transmit and receive wireless signals therebetween). However, when tools, other devices, etc., including the power tools 112, 114 are positioned outside of the direct communication range, the wireless communication device 102 can be unable to directly communicate with each of these tools, devices, etc. (e.g., because the wireless signals transmitted from the wireless communication device and to a respective device are unable to be appropriately received by the device due to, for example, interferences, wireless signal losses, too much noise, etc.).

In some embodiments, the wireless communication device 102 can be implemented in different ways. For example, the wireless communication device 102 can include components such as a processor, memory, a display, inputs (e.g., a keyboard, a mouse, a graphical user interface, a touch-screen display, one or more actuatable buttons, etc.), communication devices (e.g., an antenna and appropriate corresponding circuitry), etc. In some embodiments, the wireless communication device 102 can simply be implemented as a processor. In some specific embodiments, the wireless communication device 102 can be implemented as a mobile phone (e.g., a smart phone), a personal digital assistant (“PDA”), a laptop, a notebook, a netbook computer, a tablet computing device, etc. In some embodiments, the wireless communication device 102 can include a power source (e.g., an AC power source, a DC power source, etc.), which can be in electrical communication with one or more power outlets (e.g., AC or DC outlets) and/or one or more charging ports (e.g., for charging a battery pack of a power tool). Thus, in some cases, the wireless communication device 102 can be a portable power supply and/or a charging device for one or more power tools. In some embodiments, the wireless communication device 102 can be implemented in other ways. For example, the wireless communication device 102 can be a cellular tower, a Wi-Fi router, etc. In this way, some (or all) of the power tools 104, 106, 108, 110, 112, 114, 116, 118 can be configured to communicate with the wireless communication device 102 implemented as a cell tower (e.g., a power tool can have antennas, transmitters, transceivers, cellular modules, etc., that facilitate communication with the cellular tower so that a power tool can communicate therewith), and thus power tools that are not able to directly communicate (e.g., lack the electronic circuitry including an antenna, a transmitter, a transceiver, etc.) with the wireless communication device 102 (e.g., implemented as a cellular tower) can still indirectly communicate, via a mesh network, that includes those power tools that are configured to communicate directly with the wireless communication device 102. Thus, regardless of the configuration, and as described below, the wireless communication device 102 can receive an identifier for each power tool 104, 106, 108, 110, 112, 114, 116, 118.

Each power tool 104, 106, 108, 110, 112, 114, 116, 118 may include an actuator, a power source (e.g., a battery pack), an electronic controller, a power source interface (e.g., a battery pack interface), etc. In some cases, each power tool 104, 106, 108, 110, 112, 114, 116, 118 can be different, can be the same, etc. For example, one or more of the power tools 104, 106, 108, 110, 112, 114, 116, 118 can be an impact driver, a power drill, a hammer drill, a pipe cutter, a sander, a nailer, a grease gun, a crimper, any other suitable tool that can send data to another device, etc. Regardless of the configuration, each power tool 104, 106, 108, 110, 112, 114, 116, 118 can be configured to directly communicate with each other (e.g., over a wireless communication channel), and each power tool 104, 106, 108, 110, 112, 114, 116, 118 can be configured to communicate directly with the wireless communication device 102. In some configurations, each power tool 104, 106, 108, 110, 112, 114, 116, 118 can directly communicate with each other according to a wireless protocol, which can be a Bluetooth® wireless protocol. Similarly, each power tool 104, 106, 108, 110, 112, 114, 116, 118 can be configured to directly communicate with the wireless communication device 102 according to a wireless communication protocol, which can be a Bluetooth® wireless protocol.

In some embodiments, each power tool 104, 106, 108, 110, 112, 114, 116, 118 can include a tool identifier associated therewith, each of which uniquely identifies the respective power tool from other power tools. For example, the tool identifier can be a media access control (“MAC”) address, other unique identification information, etc.

In some cases, the power tool system 100 can include a network 120, and a server 122. Generally, the wireless communication device 102 can communicate with the server 122 via the network 120. More particularly, the wireless communication device 102 can communicate with an access point of the network 120 to communicate with the server 122 over the network 120. An access point can include, for example, a cellular tower or a Wi-Fi router. Additionally, the wireless communication device 102 can serve as a gateway device to enable a power tool to communicate with the server 122 (again, via the network 140). The server 122 can store tool data for various power tools (e.g., the power tools of the power tool system 100) including configuration data for the power tools (e.g., to configure operational parameters of the power tool), usage data for the power tools (e.g., number of hours of available operation for a power tool), maintenance data for the power tools (e.g. a log of prior maintenance, suggestions for future maintenance, etc.), operator (and owner information) for the power tools, location data for the power tools (e.g., for inventory management and tracking), among other data. In some cases, one power tool of the power tool system 100 can periodically or occasionally attempt to communicate one or more types of tool data back to the server 122, or to otherwise communicate with the server 122 or access points of the power tool system 100. The particular number, types, and locations of components with the power tool system 100 of FIG. 1 are merely used as an example for discussion purposes, and thus additional or different types of power tools, access points, networks 120, and servers 122 can be present in other embodiments of the power tool system 100.

In some embodiments, each power tool 104, 106, 108, 110, 112, 114, 116, 118, and the wireless communication device 102 can establish a mesh network, with some (or all) of the power tools 104, 106, 108, 110, 112, 114, 116, 118 (and others not shown in FIG. 1). In this way, information (including power tool identifiers associated with each power tool) can be disseminated through the mesh network, ultimately being received by the wireless communication device 102. Thus, even if some of the power tools of the power tool system 100 exceed the direct communication range of the wireless communication device 102 (e.g., being positioned at locations too far from the wireless communication device 102 and thus unable to directly communicate with the wireless communication device 102), some power tools of the power tool system 100 can act as nodes to establish indirect communication with these power tools. As such, each power tool identifier, regardless of its location relative to the wireless communication device 102, can ultimately be received by the wireless communication device 102.

In some embodiments, while each of the power tools 104, 106, 108, 110, 112, 114, 116, 118 have been described as being a node of the mesh network (e.g., when established), in some embodiments, the power tool system 100 can include one or more other wireless communication devices that can be in communication with each power tool of the power tool system 100, and the wireless communication device 102. In some cases, each of these wireless communication devices can include a power source, an antenna, a receiver, an electronic controller, etc., and each of these can be configured to communicate according to a Bluetooth® wireless protocol. In some configurations, the mesh network can be a Bluetooth® mesh network.

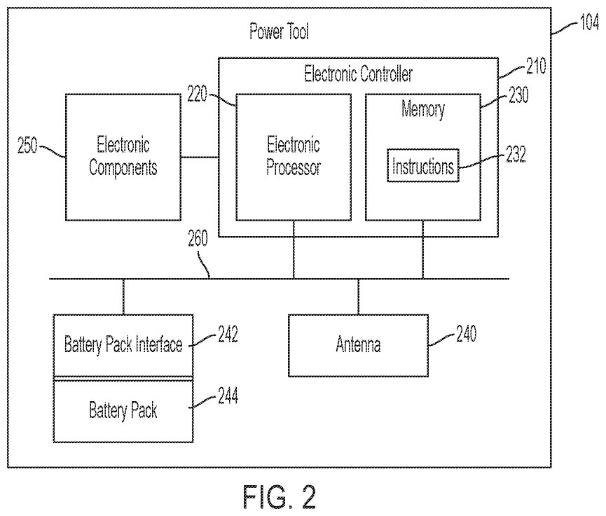

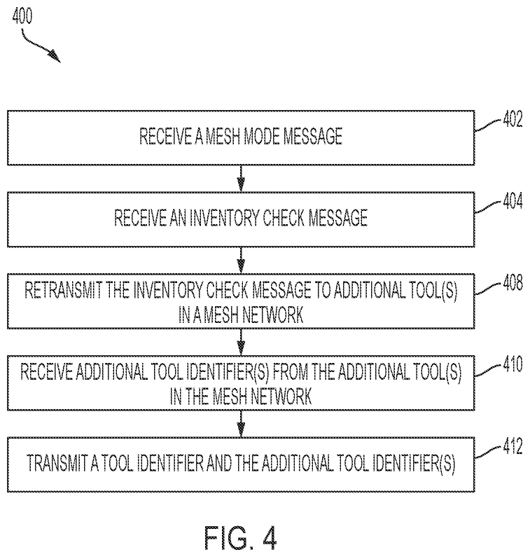

FIG. 2 shows a block diagram of an example of a power tool 104. In the example illustrated, the power tool 104 can include an electronic controller 210, an antenna 240, electronic components 250, among other components. The electronic controller 210 can include an electronic processor 220 and a memory 230. The electronic processor 220, the memory 230), and the antenna 240) can communicate over one or more control buses, data buses, etc., which can include a device communication bus 260. The electronic processor 220) can be configured to communicate with the memory 230 to store data and retrieve stored data. The electronic processor 220 can be configured to receive instructions and data from the memory 230 and execute, among other things, the instructions. In particular, the electronic processor 220 executes instructions stored in the memory 230. Thus, the electronic controller 210 coupled with the electronic processor 220 and the memory 230 can be configured to perform the methods described herein (e.g., the process 400 of FIG. 4).

The memory 230 can include read-only memory (ROM), random access memory (RAM), other non-transitory computer-readable media, or a combination thereof. The memory 230 can include instructions 232 for the electronic processor 220 to execute. The instructions 232 can include software executable by the electronic processor 220 to enable the electronic controller 210 to, among other things, determine an inventory of power tools for a location and to perform other functionality of the power tool 104 described herein, including the process 400 of FIG. 4.

The antenna 240) can be communicatively coupled to the electronic controller 210. The antenna 240) enables the electronic controller 210 (and, thus, the power tool 104) to communicate with other devices, such as a cellular tower, a Wi-Fi router, a mobile device, other power tools, a wireless communication device (e.g., device 102 of FIG. 1), or other devices of the system 100, etc. In some examples, the antenna 240 can further include a GNSS receiver configured to receive signals from GNSS satellites, land-based transmitters, etc.

In some embodiments, the power tool 104 also optionally includes a power tool battery pack interface 242 that is configured to selectively receive and interface with a power tool battery pack 244. The pack interface 242 can include one or more power terminals and, in some cases, one or more communication terminals that interface with respective power terminals, communication terminals, etc., of the power tool battery pack 244. The power tool battery pack 244 can include one or more battery cells of various chemistries, such as lithium-ion (Li-Ion), nickel cadmium (Ni-Cad), etc. The power tool battery pack 244 can further selectively latch and unlatch (e.g., with a spring-biased latching mechanism) to the power tool 104 to prevent unintentional detachment. The power tool battery pack 244 can further include a pack electronic controller (pack controller) including a processor and a memory. The pack controller can be configured similarly to the electronic controller 210 of the power tool 104. The pack controller can be configured to regulate charging and discharging of the battery cells, and/or to communicate with the electronic controller 210. In some embodiments, the power tool battery pack 244 can further include an antenna, similar to the antenna 240, coupled to the pack controller via a bus similar to bus 260. Accordingly, the pack controller, and thus the power tool battery pack 244, can be configured to communicate with other devices, such as the cellular tower, the Wi-Fi router, the mobile device, other power tools, other battery packs, a wireless communication device (e.g., device 102 of FIG. 1), or other devices of the system 100. In some embodiments, the memory of the pack controller can include the instructions 232. The power tool battery pack 244 can further include, for example, a charge level fuel gauge, analog front ends, sensors, etc.

The power tool battery pack 244 can be coupled to and configured to power the various components of the power tool 104, such as the electronic controller 210, the antenna 240, and the electronic components 250. However, to simplify the illustration, power line connections between the pack 244 and these components are not illustrated.

In some embodiments, the power tool 104 also optionally includes additional electronic components 250. For a motorized power tool (e.g., drill-driver, reciprocating saw, circular saw, cutter, crimper, sander, etc.), the electronic components 250 can include, for example, an inverter bridge, a motor (e.g., brushed or brushless) for driving a tool implement, etc. For a non-motorized power tool (e.g., a work light, a work radio, ruggedized tracking device, etc.), the electronic components 250 can include, for example, one or more of a lighting element (e.g., an LED), an audio element (e.g., a speaker), a power source, etc. In some embodiments, the antenna 240 can be within a separate housing along with the electronic controller or another electronic controller, and that separate housing selectively attaches to the power tool 104. For example, the separate housing may attach to an outside surface of the power tool 104 or may be inserted into a receptacle of the power tool 104. Accordingly, the wireless communication capabilities of the power tool 104 can reside in part on a selectively attachable communication device, rather than integrated into the power tool 104. Such selectively attachable communication devices can include electrical terminals that engage with reciprocal electrical terminals of the power tool 104 to enable communication between the respective devices and enable the power tool 104 to provide power to the selectively attachable communication device. In other embodiments, the antenna 240 can be integrated into the power tool 104.

Although described with respect to the power tool 104, in some embodiments, the diagram of FIG. 2 also applies to one or more of the other power tools 106, 108, 110, 112, 114, 116, and/or 118 of the system 100. The diagram of FIG. 2 may also apply to some embodiments of the battery pack 244, except that, in a power tool battery pack implementation, the battery pack interface 242 and the battery pack 244 of the diagram are replaced with a tool interface (to interface with a battery pack interface of a power tool). In the case of the power tool battery pack implementation, the electronic component 250 can include, for example, one or more battery cells, a charge level fuel gauge, analog front ends, sensors, etc.

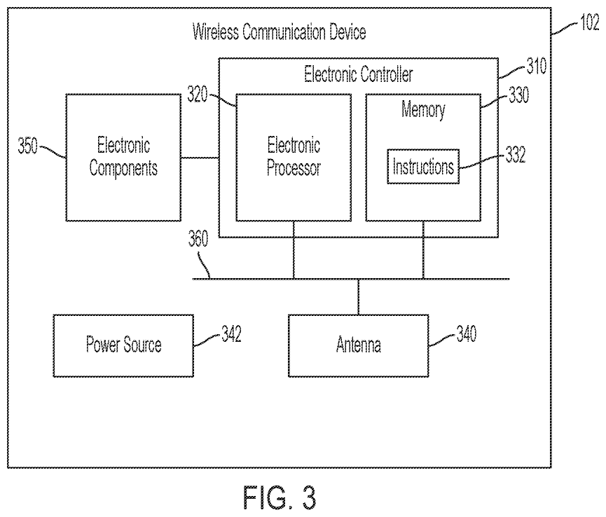

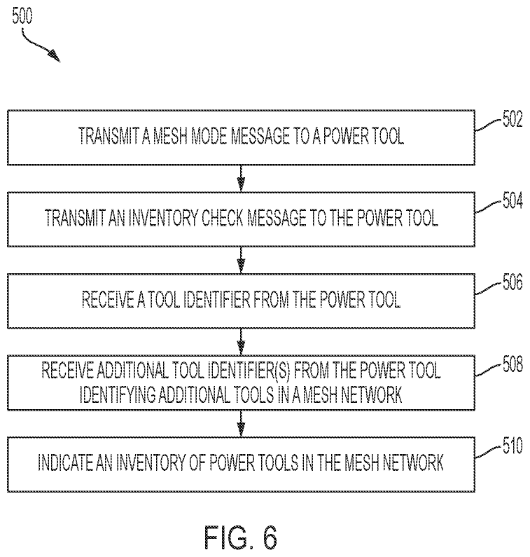

FIG. 3 shows a block diagram of a wireless communication device 102. The wireless communication device 102 can include an electronic controller 310, an antenna 340, a power source 342, and electronic components 350. In some embodiments, the electronic controller 310 can be similar to the electronic controller 210, and the antenna 340) can be similar to the antenna 240. For example, the electronic controller 310 can include an electronic processor 320 and memory 330. The electronic processor 320, the memory 330, and the antenna 340) can communicate over one or more control buses, data buses, etc., which can include a device communication bus 360. The electronic processor 320 can be configured to communicate with the memory 330 to store data and retrieve stored data. The electronic processor 320 can be configured to receive instructions and data from the memory 330 and execute, among other things, the instructions. In particular, the electronic processor 220) executes instructions stored in the memory 330. Thus, the electronic controller 310) coupled with the electronic processor 320 and the memory 330 can be configured to perform the methods described herein (e.g., the process 500 of FIG. 6).

The memory 330 can include ROM, RAM, other non-transitory computer-readable media, or a combination thereof. The memory 330 can include instructions 332 for the electronic processor 320 to execute. The instructions 332 can include software executable by the electronic processor 320 to enable the electronic controller 310 to, among other things, determine an inventory of power tools for a location. The antenna 340 can be communicatively coupled to the electronic controller 310. The antenna 340 enables the electronic controller 310 (and, thus, the wireless communication device 102) to communicate with other devices, such as a cellular tower, a Wi-Fi router, a mobile device, other power tools, etc. In some examples, the antenna 340) can further include a GNSS receiver configured to receive signals from GNSS satellites, land-based transmitters, etc.

In some embodiments, the wireless communication device 102 can include electronic components 350, which can include amplifiers, a display (e.g., an LCD display, a touch screen display), inputs (e.g., a keypad, a touch screen, a keyboard, a mouse, etc.), outputs, etc. In some embodiments, the power source 342 can be a battery, an electrical cable, etc.

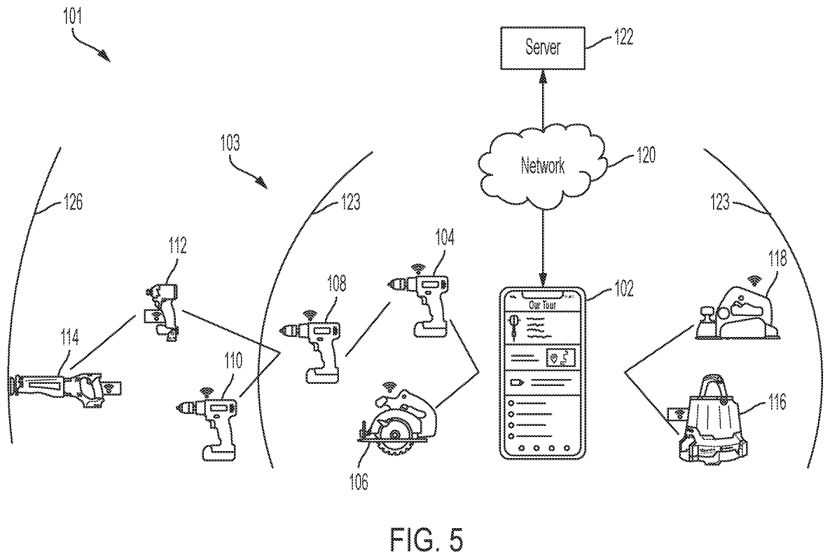

FIG. 4 illustrates a flowchart of a process 400 for implementing an inventory check in a mesh network at a location (e.g., a jobsite), which can be implemented using any of the systems described herein (e.g., the power tool system 100). However, in some embodiments, the process 400 is implemented by another system having additional components, fewer components, alternative components, etc. In some specific cases, the process 400 can be implemented using a power tool (e.g., the power tool 104). Additionally, although the blocks of the process 400 are illustrated in a particular order, in some embodiments, one or more of the blocks can be executed partially or entirely in parallel, can be executed in a different order than illustrated in FIG. 4, or can be bypassed. For illustration purposes, the process 400 is generally described as being implemented by the power tool 104 in the context of the power tool system 101 in FIG. 5. However, in other embodiments, other power tools or devices of the system 101, or other power tools or devices of other systems, may implement the process 400.

In block 402, the process 400 can include a power tool (e.g., the power tool 104) receiving a mesh mode message (e.g., using an electronic controller and an antenna of the power tool) requesting that the power tool enable a mesh communication mode. For example, the power tool 104 may receive the mesh mode message from a wireless communication device (e.g., the wireless communication device 102). The wireless communication device 102 may transmit the mesh mode message to the power tool 104 (and to other power tools) as part of a periodic inventory check or in response to a user request for an inventory check (e.g., input via a graphical user interface of the wireless communication device 102). The transmission may be a broadcast message in which the wireless communication device 102 broadcasts the mesh mode message out to every power tool or a subset of power tools that is in the direct communication range of the wireless communication device. In other cases, the transmission can include the wireless communication device 102 transmitting the mesh mode message specifically to the power tool 104. For example, the wireless communication device can establish a communication channel with the power tool 104, and can transmit the mesh mode message to the power tool 104 over the communication channel to the power tool 104 (e.g., the mesh mode message being an addressed message that is addressed to the power tool 104). In some cases, the transmission can include establishing a one-to-one pairing between the power tool 104 and the wireless communication device 102, and based on the one-to-one pairing, the wireless communication device 102 can transmit the mesh mode message to the power tool 104.

In some embodiments, in block 402, the power tool 104 enters the mesh communication mode in response to receipt of the mesh mode message. In the mesh communication mode, the power tool 104 may be configured to listen for further mesh network messages via the antenna 240 and to retransmit such wireless messages that the power tool receives via the antenna 240. Thus, in the mesh communication mode, the power tool 104 may be configured to propagate mesh network messages through the mesh network (e.g., to the communication device 102 or other power tools and devices in the network). In some embodiments, entering the mesh communication mode may further include the power tool 104 switching from a first wireless communication mode (e.g., a one-to-one Bluetooth® communication mode with another device), to a second wireless communication mode in which the power tool communicates via the mesh network (e.g., which can be a Bluetooth® mesh network).

In some embodiments, in block 402, in addition to or as part of entering the mesh communication mode, the power tool 104 further begins communicating via a mesh network. In some cases, including if a mesh network has not been established, these communications may include the power tool 104 (and/or the wireless communication device 102 and other power tools) communicating to establish the mesh network that includes the power tool 104, the wireless communication device 102, one or more other power tools, etc. In this case, the mesh network then includes at least the power tool, the wireless communication device, and each other power tool that is either in direct communication with the wireless communication device 102 or the power tool 104. In some cases, the mesh network may further include other wireless communication devices (e.g., that can act as intermediary nodes in the mesh network) and more power tools in indirect communication with the wireless communication device (e.g., via other power tools or the other wireless communication devices). In some embodiments, the mesh network is ad-hoc in the sense that the power tool 104 may not be aware of one or more other devices in the mesh network but, rather, opportunistically receives, processes, and transmits mesh network communications to and from other devices in the mesh network. In such cases, the power tool 104 may not communicate particular messages to establish the mesh network beyond the previously described mesh mode message that results in the devices being configured to receive, process, and/or transmit mesh network communications. Accordingly, in some cases, the mesh network may be described as including each power tool (or other device) configured for mesh communication and within direct communication range of at least the wireless communication device 102 or one other power tool (or other device) configured for mesh communication.

FIG. 5 shows a schematic illustration of a power tool system 101 with a mesh network 103 having been established. The power tool system 101 may be a specific implementation of the power tool system 100. Accordingly, except as otherwise noted below, the previous description of the power tool system 100 and its components similarly applies to the power tool system 101 and its components. For example, the power tool system 101 can include the wireless communication device 102, the power tools 104, 106, 108, 110, 112, 114, 116, 118, the network 120, and the server 122. Although illustrated as a smart phone in FIG. 5, the wireless communication device 102 may take various other forms as previously noted with respect to FIG. 1. As shown in FIG. 5, the wireless communication device 102 can have a direct communication range 123 and an indirect communication range 126 that is larger than the direct communication range 123. In other words, the indirect communication range 126 extends farther from the wireless communication device 102 than the direct communication range. The larger indirect communication range 126 enables the wireless communication device 102 to indirectly receive information (e.g., a tool identifier) from devices outside the direct communication range 123, which may otherwise not be received by the wireless communication device 102.

In some cases, the indirect communication range 126 can be provided by the mesh network 103 established between multiple devices of the power tool system 101. For example, as shown in FIG. 5, the mesh network 103 includes the wireless communication device 102, and each power tool 104, 106, 108, 110, 112, 114, 116, 118. In particular, in the mesh network 103 of FIG. 5, each power tool 104, 106, 116, 118 is in direct communication with the wireless communication device 102, the power tool 108 is in direct communication with the power tools 104, 110, 112, and the power tool 112 is in direct communication with the power tools 108, 114. In this way, the power tools 110, 112, 114 are in indirect communication with the wireless communication device 102, via the mesh network 103. For example, the power tool 114 can communicate with the wireless communication device 102, via the power tools 112, 108, 104, each acting as intermediary nodes (e.g., information being transmitted from the power tool 114 and to the power tool 112, then being transmitted from the power tool 112 and to the power tool 108, then being transmitted from the power tool 108 and to the power tool 104, and then being transmitted from the power tool 104 and to the wireless communication device 102). With the mesh network 103 established, information including tool identifiers for each tool within the mesh network 103 can be disseminated therethrough, ultimately leading to the wireless communication device 102 receiving the information (e.g., each tool identifier for each power tool in the mesh network).

In the illustration of FIG. 5, only select communication paths of the mesh network are illustrated—additional communication paths exist in some embodiments of the mesh network 103. For example, the power tool 104 may directly communicate with the power tool 106 and/or the power tool 112, even though a communication path is not illustrated. Additionally, as the devices in the mesh network 103 (e.g., the power tools 104-118 and the wireless communication device 102) move relative to one another, the particular configuration of the mesh network 103 and available communication paths between devices may change. For example, the power tool 114 may be moved near the wireless communication device and enter the direct communication range 123. Additionally, the power tool 106 may be moved away from the wireless communication device 102, out of the direct communication range 123 and into the indirect communication range 126.

Referring back to FIG. 4, the process 400 can include disseminating the mesh mode message through some (or all) power tools of the mesh network. For example, after the power tool (e.g., the power tool 104) receives the mesh mode message in block 402, the power tool 104 can subsequently transmit the mesh mode message to other power tools (or other devices) in direct communication therewith. This reception and transmission of the mesh mode message can continue until each power tool or device in the mesh network 103 receives the mesh mode message. For example, the power tool 104 can transmit the mesh mode message to the power tool 108, which can retransmit the mesh mode message to the power tool 112, which can retransmit the mesh mode message to the power tool 114.

In block 404, the process 400 can include the power tool receiving an inventory check message that originates from a wireless communication device. For example, the power tool 104 may receive the inventory check message directly from the wireless communication device 102, or indirectly through another node (e.g., another power tool) in the mesh network 103. Whether received indirectly or directly, the inventory check message may originate at the wireless communication device 102. The wireless communication device 102 may wait a period of time after transmitting the mesh mode message before transmitting the inventory check message. This period of time may ensure that the power tool 104 has received the mesh mode message, entered into the mesh network mode, and retransmitted the mesh mode message such that other power tools in the mesh network 103 may similarly enter the mesh network mode and retransmit the mesh mode message. Thus, in some examples, the wireless communication device 102 may wait a period of time to ensure that the mesh network 103 is established before transmitting the inventory check message. In some cases, the inventory check message may indicate a request that the power tool 104 one or more of transmit a tool identifier associated therewith (e.g., the tool identifier of the power tool), retransmit the inventory check message in the mesh network 103, or transmit any other tool identifiers associated with other power tools in the mesh network 103 that have already been received or that will be received by the power tool 104 within a certain time period.

In block 408, the process 400 can include the power tool retransmitting the inventory check message to one or more additional tools in the mesh network. For example, the power tool 104 may retransmit the inventory check message to one or more of the power tools 106, 108, 110, 112, or 114. The retransmission of the inventory check message may include a broadcast message such that any devices in the mesh network 103 within direct communication range of the power tool 104 may receive the inventory check message. Additionally or alternatively, the retransmission may include one or more particularly addressed messages to other power tools in the mesh network 103 known to the power tool 104. The other power tools in the mesh network 103 may be known to the power tool 104 based on prior communications with such power tools (e.g., when establishing the mesh network 103) or from an inventory list provided to the power tool 104 (e.g., from the wireless communication device 102).

In block 410, the process 400 can include the power tool receiving additional tool identifier(s) from the one or more additional tools in the mesh network. For example, after receiving the retransmitted inventory check message, each of the one or more additional power tools in the mesh network 103 can transmit a tool identifier associated with the respective additional power tool. In some cases, the tool identifier may be received directly from the power tool associated with the tool identifier. For example, the power tool 104 may receive a first tool identifier from the power tool 108 via direct wireless communication and a second tool identifier from the power tool 112 via another direct wireless communication. In some cases, in block 410, a tool identifier may be received indirectly from a power tool associated with the tool identifier. For example, the power tool 104 may receive a third tool identifier from the power tool 114 indirectly via the power tool 112 and/or the power tool 108. For example, the power tool 114 may transmit the third tool identifier in response to receiving a retransmitted version of the inventory check message described with respect to the previous block 408 (e.g., originating at the wireless communication device 102, and being retransmitted by one or more of the power tool 104, the power tool 108, or the power tool 112). The power tool 112 and/or the power tool 108 may receive the third tool identifier and retransmit the third tool identifier, which is then received (eventually) by the power tool 104. In some examples, the power tool 104 may receive a tool identifier from one or more of the additional tools in the mesh network 103 that is transmitted by the respective additional tool in response to another triggering event other than the inventory check message. For example, the power tools 108, 112, and/or 114 may transmit the first, second, and/or third tool identifier, respectively, periodically (e.g., every 100 milliseconds, 1 second, 10 seconds, etc.) or as part of establishing the mesh network 103.

In block 412, the process 400 can include the power tool transmitting, in response to the inventory check message, a tool identifier for the power tool and the additional tool identifier(s) for the one or more additional tools. For example, the power tool 104 may transmit the tool identifier (of the power tool 104) and the additional tool identifier(s) (e.g., of the power tool 108, 112, and/or 114) to the wireless communication device 102. When the power tool 104 is within the direct communication range 123 (as illustrated in FIG. 5), the power tool 104 may transmit the tool identifiers directly to the wireless communication device 102. When the power tool 104 is outside of the direct communication range 123, the power tool 104 may transmit the tool identifiers indirectly to the wireless communication device 102 (e.g., via other power tools of the mesh network 103). The power tool 104 may transmit the tool identifier and the additional tool identifier(s) in one message or distributed among multiple messages. For example, the power tool 104 may transmit the tool identifier before the power tool 104 retransmits the inventory check message (in block 408) and/or before the power tool 104 receives the additional tool identifier(s) (in block 410), and then transmit the additional tool identifier(s) as a group after receiving the additional tool identifier(s) or one-by-one as the power tool 104 receives each additional tool identifier. In some examples, the block 402 is optional and is bypassed in the process 400. For example, the power tool 104 (and other power tools in the mesh network 103) may already be pre-configured in a mesh mode and, accordingly, a mesh mode message is not received by the power tool 104 in the process 400.

In some embodiments, the process 400 can include the wireless communication device receiving one or more tool identifiers each corresponding to a respective power tool in the mesh network. In some cases, the process 400 can include the wireless communication device determining an inventory for a location, based on the one or more tool identifiers. For example, each tool identifier can indicate the presence of the corresponding power tool within the mesh network, and each tool identifier can include a tool type identifier that indicates the specific type of tool (e.g., a crimper, a drill, a saw, etc.). In this way, the wireless communication device can determine the inventory by listing information associated with each tool identifier (e.g., a graphic, a name, a number, etc.) and the tool type associated with each tool identifier indicating the type of tool.

FIG. 6 illustrates a flowchart of a process 500 for determining an inventory in a mesh network for a location (e.g., a jobsite), which can be implemented using any of the systems described herein (e.g., the power tool system 100). However, in some embodiments, the process 500 can be implemented by another system having additional components, fewer components, alternative components, etc. In some specific cases, the process 500 can be implemented using a wireless communication device (e.g., the wireless communication device 102). Additionally, although the blocks of the process 500 are illustrated in a particular order, in some embodiments, one or more of the blocks can be executed partially or entirely in parallel, can be executed in a different order than illustrated in FIG. 6, or can be bypassed. For illustration purposes, the process 500 is generally described as being implemented by the wireless communication device 102 in the context of the power tool system 101 in FIG. 5. However, in other embodiments, other wireless communication devices may implement the process 500.

In the block 502, the process 500 can include a wireless communication device (e.g., the wireless communication device 102) transmitting a mesh mode message to a power tool (e.g., the power tool 104) requesting that the power tool enable a mesh communication mode. For example, the wireless communication device 102 may transmit the mesh mode message to the power tool 104 as described with respect to the block 402 of FIG. 4 above. Further, as described with respect to blocks 402, the power tool 104 may retransmit the mesh mode message to disseminate the message through the mesh network 103. In some examples, the mesh mode message may include an indication of a request that the power tool 104 retransmit the mesh mode message in the mesh network 103. In some examples, in block 502, the wireless communication device 102 transmits the mesh mode message to multiple power tools, such as each power tool within direct communication range 123. For example, with respect to FIG. 5, the wireless communication device 102 may (directly) transmit the mesh mode message to power tools 104, 106, 108, 116, and 118. The wireless communication device 102 may broadcast the mesh mode message to these power tools or send the mesh mode message to these power tools one-by-one (e.g., individually addressed). The receiving power tools may retransmit the inventory check message to disseminate the message through the mesh network 103. In the block 504, the process 500 can include the wireless communication device transmitting an inventory check message to the power tool, which can be similar to the description of the block 404. For example, the wireless communication device 102 may transmit the inventory check message to the power tool 104 as described with respect to the block 402 of FIG. 4 above. Further, as described with respect to blocks 408, the power tool 104 may retransmit the inventory check message to disseminate the message through the mesh network 103. In some examples, the inventory check message may include an indication of a request that the power tool 104 retransmit the inventory check message in the mesh network 103. In some examples, in block 504, the wireless communication device 102 transmits the inventory check message to multiple power tools, such as each power tool within direct communication range 123. For example, with respect to FIG. 5, the wireless communication device 102 may (directly) transmit the inventory check message to power tools 104, 106, 108, 116, and 118. The wireless communication device 102 may broadcast the inventory check message to these power tools or send the inventory check message to these power tools one-by-one (e.g., individually addressed). The receiving power tools may retransmit the inventory check message to disseminate the message through the mesh network 103.

In the block 506, the process 500 can include the wireless communication device receiving a tool identifier from the power tool. The wireless communication device may receive the tool identifier in response to the inventory check message that the wireless communication device transmitted. For example, as described with respect to block 412 of FIG. 4, the power tool 104 may transmit (directly or indirectly) the tool identifier for the power tool 104 to the wireless communication device 102 in response to the power tool 104 receiving the inventory check message. Further, in response to sending the inventory check message, the wireless communication device 102 may be listening (e.g., analyzing incoming signals received via an antenna) for such tool identifiers from power tools in the mesh network 103.

In the block 508, the process 500 can include the wireless communication device receiving additional tool identifier(s) from the power tool identifying additional tools (e.g., other than the power tool) in the mesh network. The wireless communication device may receive the additional tool identifier(s) in response to the inventory check message that the wireless communication device transmitted. For example, as described with respect to block 412 of FIG. 4, the power tool 104 may transmit (directly or indirectly) the additional tool identifier(s) for other power tools of the mesh network 103 to the wireless communication device 102 in response to the power tool 104 receiving the inventory check message. Further, in response to sending the inventory check message, the wireless communication device 102 may be listening (e.g., analyzing incoming signals received via an antenna) for such tool identifiers from power tools in the mesh network 103. The wireless communication device 102 may receive the tool identifier (of block 506) and the additional tool identifier(s) (of block 508) in one message or distributed among multiple messages. For example, blocks 506 and 508 may occur in parallel when the wireless communication device 102 receives of a message from the power tool 104 including both the tool identifier and the additional tool identifiers. In some examples, blocks 506 and 508 may occur serially, e.g., when the wireless communication device 102 receives the tool identifier for the power tool 104 in a separate message than a message including the additional tool identifier(s).

In some cases, in blocks 506 and/or 508, the wireless communication device 102 can receive, from each power tool in the mesh network 103 that is in direct communication range 123, a corresponding tool identifier associated with the respective power tool, and any other tool identifier received by the respective power tool. For example, each power tool (e.g., after receiving a broadcast inventory check message) can transmit the tool identifier associated with the respective tool, and any additional tool identifiers received by the respective tool, to the wireless communication device 102. As another example, the wireless communication device 102 can communicate an inventory check message directly to each power tool in direct communication with the wireless communication device (e.g., in an ordered manner) so that each power tool can transmit the tool identifier associated therewith (and any additional tool identifiers received by the respective tool) to the wireless communication device 102.

In some embodiments, the process 500 can include the wireless communication device determining an inventory of power tools (in the mesh network), based on the received tool identifier and the additional tool identifier(s). For example, this determination can include the wireless communication device 102 generating an inventory list with information indicative of each tool identifier (e.g., the tool identifier for the power tool 104 and the additional tool identifier(s)), which can correspond to the presence of each associated power tool in the mesh network 103. In some cases, the inventory list can include, for each tool identifier, a tool type that corresponds to the tool type identifier (e.g., that is part of the tool identifier). In this way, the wireless communication device 102 can determine an inventory (a determined inventory) that includes, for each tool identifier, information associated with the respective tool identifier (e.g., a graphic), and for each tool identifier, a tool type that corresponds to the respective tool identifier. The determined inventory may also be referred to as a present tool inventory. In some cases, the information associated with the respective tool identifier can also include information associated with the tool type corresponding to the respective tool. For example, the information associated with the respective tool can be a graphic of a power tool (e.g., a crimper or impact driver) that is the tool type associated with the respective tool (e.g., a crimper or impact driver).

In some cases, the process 500 can include the wireless communication device comparing the determined inventory to a predetermined inventory (e.g., that includes all the power tools owned by a company, desired to be brought to the location (e.g., a worksite), assigned to a particular operator, assigned to a particular location, etc.). Correspondingly, the wireless communication device can determine a resulting inventory that includes only those power tools appearing in the predetermined inventory but not appearing in the determined inventory (i.e., including missing power tools). The resulting inventory may also be referred to as a missing tool inventory. In some cases, the wireless communication device can determine another inventory that includes information associated with each tool identifier received, and information associated for any tool identifier (or other indicative information) that is in the predetermined inventory but is not located in the determined inventory. In some configurations, this information for tool identifiers not located in the determined inventory can be indicated in the additional inventory (e.g., listed as “missing”). The additional inventory may also be referred to as a present/missing tool inventory.

In the block 510, the process 500 can include the wireless communication device (e.g., the wireless communication device 102) indicating an inventory of power tools (in the mesh network). In some cases, this inventory can be one or more of the determined inventory, the resulting inventory, or the additional inventory. In some cases, to indicate the inventory, the wireless communication device 102 can present the inventory on a display (e.g., of the wireless communication device), can store the inventory in memory (e.g., of the wireless communication device), and/or can transmit the inventory to a server or other wireless communication device, either of which may be a remote device remotely located at an off-site location. In some cases, the other communication devices (or the server) can store the inventory in memory.

Below, three tables are provided as examples of each of a determined inventory (Table 1), resulting inventory (Table 2), and additional inventory (Table 3) that may be determined and indicated (in block 510) of the process 500. The tables provide examples of inventories that may be determined and indicated based on the power tools in the mesh network 103 of FIG. 5, and presuming that the operator of the wireless communication device 102 includes a predetermined inventory of the eight power tools illustrated in FIG. 5 and four additional power tools. In some examples, the wireless communication device 102 may display or output an inventory as part of block 510 of the process 500 in a similar format as provided in the below tables (except without the left-most column indicating the label used in FIG. 5). In other examples, the indicated inventory of block 510 may include more information for each tool (e.g., one or more of a graphic of the tool type, a nickname, a battery power level, maintenance information, operational information, operator information, owner information, etc.), less information for each tool, or different information for each tool, or may organize or illustrate the information in a different manner. In the examples of Tables 1-3, the last four digits of the tool identifier indicate the tool type, the first seven digits of the tool identifier (alone or in combination with the last four digits) provide a unique tool identifier for each tool (e.g., for the manufacturer, operator, wireless communication device 102, and/or server 122 to distinguish each tool from any other tool). However, the particular size and format of the tool identifier varies in different examples.

TABLE 1
Determined (Present Tool) Inventory

| Tool Label in FIG. 5 | Tool Identifier | Tool Type |
|---|---|---|
| Power Tool 104 | 1234561-0011 | Drill-Driver |
| Power Tool 106 | 1234562-0012 | Circular Saw |
| Power Tool 108 | 1234563-0011 | Drill-Driver |
| Power Tool 110 | 1234564-0011 | Drill-Driver |
| Power Tool 112 | 1234565-0013 | Impact Driver |
| Power Tool 114 | 1234566-0014 | Reciprocating Saw |
| Power Tool 116 | 1234567-0012 | Work Light |
| Power Tool 118 | 1234568-0015 | Planer |

TABLE 2
Resulting (Missing Tool) Inventory

| Tool Label in FIG. 5 | Tool Identifier | Tool Type |
|---|---|---|
| Not applicable | 1234571-0011 | Drill-Driver |
| (not shown in FIG. 5) | | |
| Not applicable | 1234572-0012 | Circular Saw |
| (not shown in FIG. 5) | | |
| Not applicable | 1234573-0016 | Work Flood Light |
| (not shown in FIG. 5) | | |
| Not applicable | 1234574-0017 | Hydraulic Crimper |
| (not shown in FIG. 5) | | |

TABLE 3
Additional (Present/Missing Tool) Inventory

| Tool Label in | Tool | | Inventory |
|---|---|---|---|
| FIG. 5 | Identifier | Tool Type | Check Status |
| Power Tool 104 | 1234561-0011 | Drill-Driver | Present |
| Power Tool 106 | 1234562-0012 | Circular Saw | Present |
| Power Tool 108 | 1234563-0011 | Drill-Driver | Present |
| Power Tool 110 | 1234564-0011 | Drill-Driver | Present |
| Power Tool 112 | 1234565-0013 | Impact Driver | Present |
| Power Tool 114 | 1234566-0014 | Reciprocating Saw | Present |
| Power Tool 116 | 1234567-0012 | Work Light | Present |
| Power Tool 118 | 1234568-0015 | Planer | Present |
| Not applicable | 1234571-0011 | Drill-Driver | Missing |
| Not applicable | 1234572-0012 | Circular Saw | Missing |
| Not applicable | 1234573-0016 | Work Flood Light | Missing |
| Not applicable | 1234574-0017 | Hydraulic Crimper | Missing |

While the disclosure has been mainly framed around power tools, it is also contemplated that the embodiments of the disclosure can be applied to tools in general (e.g., both powered and non-powered tools) and to power tool battery packs. For example, the power tool system 100 or 101 may include one or more non-powered tools (e.g., a wrench, a screwdriver, a ratchet, etc.) that have attached thereto a power source (e.g., a battery) and a communication system. The communication system may include an electronic controller (similar to electronic controller 210) and an antenna (similar to antenna 240) to facilitate communication with other devices of the system 100 or 101 (e.g., the wireless communication device 102 and power tools). In a specific case, the power source and the communication system can be coupled to a housing of a non-powered tool or can be located within the housing of the non-powered tool (e.g., within the handle of the non-powered tool). Accordingly, such non-powered tools may implement the process 400 of FIG. 4 (e.g., receiving mesh mode message, inventory check message, retransmitting the inventory check message, and transmitting a tool identifier and additional tool identifier(s)) and may be integrated into the process 500 of FIG. 5 (in a similar manner as power tools are integrated in the process 500).

Additionally or alternatively, the power tool systems 100 or 101 may include one or more power tool battery packs similar to the power tool battery pack 244. As previously noted, the power tool battery pack 244 can include a pack electronic controller (pack controller) configured to communicate with other devices. For example, the power tool battery pack 244 may communicate with the wireless communication device 102 and/or other power tools or battery packs of the system 100 or 101. Accordingly, in some embodiments, the power tool battery pack 244 may implement the process 400 of FIG. 4 (e.g., receiving mesh mode message, inventory check message, retransmitting the inventory check message, and transmitting a pack identifier and additional tool/pack identifier(s)) and may be integrated into the process 500 of FIG. 6 (in a similar manner as power tools are integrated in the process 500). In some examples, the mesh network 103 includes a combination of one or more of power tools, non-powered tools, and/or power tool battery packs in communication with the wireless communication device 102. In some examples, the mesh network 103 includes only power tools, only non-powered tools, or only power tool battery packs in communication with the wireless communication device 102. Regardless of the particular make-up of the mesh network 103, the wireless communication device 102 may implement the process 500 (with the devices present in the mesh network 103) and any of the other devices in the mesh network 103 (e.g., a power tool, non-powered tool, or power tool battery pack) can implement the process 400. For example, in the case of a mesh network 103 including only power tool battery packs in communication with the wireless communication device 102, each of the identifiers in blocks 410 and 412 may be a pack identifier, rather than a tool identifier. The term power tool device may be used to refer to a power tool (e.g., power tool 104), whether motorized or non-motorized, and/or to refer to a power tool battery pack that can attach to and power a power tool. Accordingly, a power tool device may implement the process 400 of FIG. 4, and the power tool device may retransmit the inventory check message to one or more power tool devices and receive additional device identifiers from the one or more power tool devices. Similarly, the wireless communication device 102 may implement the process 500 of FIG. 5 with respect to a mesh network including power tool devices and, accordingly, may transmit a mesh mode message (block 502) and inventory check message (block 504) to a power tool device, receive a device identifier from the power tool device (block 506), receive additional device identifiers from one or more power tool devices (block 508), and indicate an inventory of the power tool devices in the mesh network (block 510).

In some embodiments of the process 400, in block 408, the power tool 104 also retransmits the inventory check message (as part of the same or a different retransmission) to at least one power tool battery pack 244 in the mesh network 103. Then, in block 410, the power tool 104 may further receive a pack identifier from each of the at least one power tool battery packs in the mesh network 103. In block 412, the power tool 104 may further transmit, in response to the inventory check message, each of the pack identifiers.

In some embodiments of the process 500, the wireless communication device 102 further receives a pack identifier from the power tool, the pack identifier identifying a power tool battery pack 244 in the mesh network 103. Then, in block 510, the wireless communication device 102 may further indicate a presence of the power tool battery pack in the inventory based on receipt of the pack identifier.

In some embodiments, the block 502 is optional and is bypassed in the process 500. For example, the power tool 104 (and other power tools in the mesh network 103) may already be pre-configured in a mesh mode and, accordingly, a mesh mode message is not transmitted by the wireless communication device 102 in the process 500.

In some embodiments, the power tool systems 100 or 101 may implement the processes 400 and 500 in parallel. For example, the power tool 104 may execute the process 400 while the wireless communication device 102 executes the process 500. For example, the wireless communication device 102 may transmit messages, as described in blocks 502 and 504, which are received by the power tool 104 as described in blocks 402 and 404. Similarly, the wireless communication device 102 may receive tool identifiers, as described in blocks 506 and 508, which are transmitted by the power tool 104 as described in blocks 412.

It is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

As used herein, unless otherwise limited or defined, discussion of particular directions is provided by example only, with regard to particular embodiments or relevant illustrations. For example, discussion of “top,” “front,” or “back” features is generally intended as a description only of the orientation of such features relative to a reference frame of a particular example or illustration. Correspondingly, for example, a “top” feature can sometimes be disposed below a “bottom” feature (and so on), in some arrangements or embodiments. Further, references to particular rotational or other movements (e.g., counterclockwise rotation) is generally intended as a description only of movement relative a reference frame of a particular example of illustration.

In some embodiments, including computerized implementations of methods according to the disclosure, can be implemented as a system, method, apparatus, or article of manufacture using standard programming or engineering techniques to produce software, firmware, hardware, or any combination thereof to control a processor device (e.g., a serial or parallel processor chip, a single- or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, embodiments of the disclosure can be implemented as a set of instructions, tangibly embodied on a non-transitory computer-readable media, such that a processor device can implement the instructions based upon reading the instructions from the computer-readable media. Some embodiments of the disclosure can include (or utilize) a control device such as an automation device, a computer including various computer hardware, software, firmware, and so on, consistent with the discussion below. As specific examples, a control device can include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.). Also, functions performed by multiple components can be consolidated and performed by a single component. Similarly, the functions described herein as being performed by one component can be performed by multiple components in a distributed manner. Additionally, a component described as performing particular functionality can also perform additional functionality not described herein. For example, a device or structure that is “configured” in a certain way is configured in at least that way, but can also be configured in ways that are not listed.

The term “article of manufacture” as used herein is intended to encompass a computer program accessible from any computer-readable device, carrier (e.g., non-transitory signals), or media (e.g., non-transitory media). For example, computer-readable media can include but are not limited to magnetic storage devices (e.g., hard disk, floppy disk, magnetic strips, and so on), optical disks (e.g., compact disk (CD), digital versatile disk (DVD), and so on), smart cards, and flash memory devices (e.g., card, stick, and so on). Additionally it should be appreciated that a carrier wave can be employed to carry computer-readable electronic data such as those used in transmitting and receiving electronic mail or in accessing a network such as the Internet or a local area network (LAN). Those skilled in the art will recognize that many modifications can be made to these configurations without departing from the scope or spirit of the claimed subject matter.

Certain operations of methods according to the disclosure, or of systems executing those methods, can be represented schematically in the figures or otherwise discussed herein. Unless otherwise specified or limited, representation in the figures of particular operations in particular spatial order can not necessarily require those operations to be executed in a particular sequence corresponding to the particular spatial order. Correspondingly, certain operations represented in the figures, or otherwise disclosed herein, can be executed in different orders than are expressly illustrated or described, as appropriate for particular embodiments of the disclosure. Further, in some embodiments, certain operations can be executed in parallel, including by dedicated parallel processing devices, or separate computing devices configured to interoperate as part of a large system.

As used herein in the context of computer implementation, unless otherwise specified or limited, the terms “component.” “system.” “module,” etc. are intended to encompass part or all of computer-related systems that include hardware, software, a combination of hardware and software, or software in execution. For example, a component can be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) can reside within a process or thread of execution, can be localized on one computer, can be distributed between two or more computers or other processor devices, or can be included within another component (or system, module, and so on).

In some implementations, devices or systems disclosed herein can be utilized or installed using methods embodying aspects of the disclosure. Correspondingly, description herein of particular features, capabilities, or intended purposes of a device or system is generally intended to inherently include disclosure of a method of using such features for the intended purposes, a method of implementing such capabilities, and a method of installing disclosed (or otherwise known) components to support these purposes or capabilities. Similarly, unless otherwise indicated or limited, discussion herein of any method of manufacturing or using a particular device or system, including installing the device or system, is intended to inherently include disclosure, as embodiments of the disclosure, of the utilized features and implemented capabilities of such device or system.

As used herein, unless otherwise defined or limited, ordinal numbers are used herein for convenience of reference based generally on the order in which particular components are presented for the relevant part of the disclosure. In this regard, for example, designations such as “first,” “second,” etc., generally indicate only the order in which the relevant component is introduced for discussion and generally do not indicate or require a particular spatial arrangement, functional or structural primacy or order.

As used herein, unless otherwise defined or limited, directional terms are used for convenience of reference for discussion of particular figures or examples. For example, references to downward (or other) directions or top (or other) positions can be used to discuss aspects of a particular example or figure, but do not necessarily require similar orientation or geometry in all installations or configurations.

As used herein, unless otherwise defined or limited, the phase “and/or” used with two or more items is intended to cover the items individually and the items together. For example, a device having “a and/or b” is intended to cover: a device having a (but not b): a device having b (but not a); and a device having both a and b.

This discussion is presented to enable a person skilled in the art to make and use embodiments of the disclosure. Various modifications to the illustrated examples will be readily apparent to those skilled in the art, and the generic principles herein can be applied to other examples and applications without departing from the principles disclosed herein. Thus, embodiments of the disclosure are not intended to be limited to embodiments shown, but are to be accorded the widest scope consistent with the principles and features disclosed herein and the claims below. The following detailed description is to be read with reference to the figures, in which like elements in different figures have like reference numerals. The figures, which are not necessarily to scale, depict selected examples and are not intended to limit the scope of the disclosure. Skilled artisans will recognize the examples provided herein have many useful alternatives and fall within the scope of the disclosure.

Various features and advantages of the disclosure are set forth in the following claims.

1. A power tool comprising:
a body;
an actuator coupled to the body;
an antenna coupled to the body, and
an electronic controller coupled to the body and in communication with the antenna, the electronic controller including a processor and configured to:
receive a mesh mode message requesting that the power tool enable a mesh communication mode;
receive an inventory check message originating from a wireless communication device;
retransmit the inventory check message to at least one additional power tool in a mesh network with the power tool;
receive an additional tool identifier from each of the at least one additional power tools in the mesh network; and
transmit, in response to the inventory check message, a tool identifier for the power tool and each of the additional tool identifiers.

2. The power tool of claim 1, wherein the power tool is in direct communication with the wireless communication device, and
wherein the at least one additional power tool is in indirect communication with the wireless communication device via the power tool.

3. The power tool of claim 2, wherein the at least one additional power tool is positioned at a distance from the wireless communication device in which the at least one additional power tool is outside of a direct communication range of the wireless communication device.

4. The power tool of claim 1, wherein the tool identifier indicates a tool type for the power tool.

5. The power tool of claim 1, wherein, to transmit the tool identifier and each of the additional tool identifiers, the electronic controller is configured to transmit the tool identifier in a first message and each of the additional tool identifiers in one or more further messages.

6. The power tool of claim 1, wherein the electronic controller is further configured to retransmit the mesh mode message to the at least one additional power tool.

7. The power tool of claim 1, wherein the electronic controller is further configured to
retransmit the inventory check message to at least one power tool battery pack in the mesh network;
receive a pack identifier from each of the at least one power tool battery packs in the mesh network; and
transmit, in response to the inventory check message, each of the pack identifiers.

8. A method for determining an inventory for a location, the method comprising:
receiving, using a power tool, a mesh mode message requesting that the power tool enable a mesh communication mode;
receiving, using the power tool, an inventory check message originating from a wireless communication device;
retransmitting, using the power tool, the inventory check message to at least one additional power tool in a mesh network with the power tool;
receiving, using the power tool, an additional tool identifier from each of the at least one additional power tools in the mesh network; and
transmitting, using the power tool and in response to the inventory check message, a tool identifier for the power tool and each of the additional tool identifiers to the wireless communication device.

9. The method of claim 8, wherein the power tool is in direct communication with the wireless communication device, and
wherein the at least one additional power tool is in indirect communication with the wireless communication device via the power tool.

10. The method of claim 9, wherein the at least one additional power tool is positioned at a distance from the wireless communication device in which the at least one additional power tool is outside of a direct communication range of the wireless communication device.

11. The method of claim 8, wherein the tool identifier indicates a tool type for the power tool.

12. The method of claim 8, wherein transmitting the tool identifier and each of the additional tool identifiers comprises:
transmitting the tool identifier in a first message and each of the additional tool identifiers in one or more further messages.

13. The method of claim 8, further comprising:
retransmitting the mesh mode message to the at least one additional power tool.

14. The method of claim 8, further comprising:
retransmitting the inventory check message to at least one power tool battery pack in the mesh network;
receiving a pack identifier from each of the at least one power tool battery packs in the mesh network; and
transmitting, in response to the inventory check message, each of the pack identifiers.

15. A wireless communication device comprising:
a body;
an antenna coupled to the body; and
an electronic controller coupled to the body and in communication with the antenna, the electronic controller including a processor and configured to:
transmit a mesh mode message to a power tool, the mesh mode message requesting that the power tool enable a mesh communication mode;
transmit an inventory check message to the power tool;
in response to the inventory check message:
receive a tool identifier from the power tool, the tool identifier identifying the power tool, and
receive at least one additional tool identifier from the power tool, each of the at least one additional tool identifiers identifying a respective additional power tool that is in a mesh network with the power tool; and
indicate an inventory of power tools in the mesh network, the inventory of power tools indicating a presence of the power tool and each additional power tool based on receipt of the tool identifier and the at least one additional tool identifier.

16. The wireless communication device of claim 15, wherein the power tool is in direct communication with the wireless communication device, and
wherein each additional power tool is in indirect communication with the wireless communication device via the power tool.

17. The wireless communication device of claim 16, wherein each additional power tool is positioned at a distance from the wireless communication device in which each additional power tool is outside of a direct communication range of the wireless communication device.

18. The wireless communication device of claim 15, wherein the tool identifier indicates a tool type for the power tool.

19. The wireless communication device of claim 15, wherein the electronic controller is further configured to:
receive a pack identifier from the power tool, the pack identifier identifying a power tool battery pack in the mesh network,
wherein the inventory of power tools further indicates a presence of the power tool battery pack based on receipt of the pack identifier.

20. The wireless communication device of claim 15, wherein, to indicate the inventory, the electronic controller is further configured to one or more of:
display the inventory on a display of the wireless communication device: or
transmit the inventory, via a network, to a remote device.
